(19) United States
(12) Patent Application Publication
(10) Pub. No.: US 2004/0243379 A1
(43) Pub. Date: Dec. 2, 2004

(54) Ideal machine simulator with infinite resources to predict processor design performance

(76) Inventor: Dominic Paulraj, Sunnyvale, CA (US)

Correspondence Address: HAMILTON & TERRILE, LLP, P.O. BOX 203518, AUSTIN, TX, 78720, US

(21) Appl. No.: 10/447,551

(22) Filed: May 29, 2003

(51) Int. Cl. G06F 9/45

(52) U.S. Cl. 703/22

(57) ABSTRACT

A method of evaluating the performance of an application on a processor includes simulating an ideal processor having infinite resources and executing an existing application on this ideal processor. The method advantageously allows determination of bottlenecks in the application on an existing architecture based upon the performance of the application on the ideal processor. Additionally by compiling an application for an ideal processor and executing the application on the ideal processor, performance improvement opportunities may be identified and evaluated. Such a system assists in determining which parts of an application, even with infinite processor resources, do not use all the resources of a processor. By identifying the used resources, the application then can be configured to optimize these resources and thus to obtain a maximum possible performance for the application. Determining the maximum performance obtainable using the infinite resources as a baseline, processor and application architects can now design an architecture based on constraints such as cost, time, signal, power, chip area, etc.

### BACKGROUND OF THE INVENTION

1. Field of the Invention

The present invention relates to predicting performance of processor designs.

2. Description of the Related Art

Processor architectural design decisions are often made based on performance obtained using an existing processor architecture. Processor architects often start with a known processor architecture and develop improvements to the architecture (i.e., delta improvements) to develop a new processor architecture. The processor architect may then use a cycle accurate simulator on the new processor architecture to obtain performance information for the new processor architecture.

However, these delta improvements do not consider the overall performance available in a real world application. The overall performance is not considered because the tools used to evaluate the performance for the new processor architecture are restricted in terms of the resources.

However, evaluating the performance of a new processor architecture based on the above existing tools, does not provide the processor architect with information regarding the overall performance that the processor architecture.

### SUMMARY OF THE INVENTION

In accordance with the present invention, a method of evaluating the performance of an application on a processor includes simulating an ideal processor having infinite resources and executing an existing application on this ideal processor. The method advantageously allows determination of bottlenecks in the application on an existing architecture based upon the performance of the application on the ideal processor.

Additionally by compiling an application for an ideal processor and executing the application on the ideal processor, performance improvement opportunities may be identified and evaluated. Such a system assists in determining which parts of an application, even with infinite processor resources, do not use all the resources of a processor. By identifying the used resources, the application then can be configured to optimize these resources and thus to obtain a maximum possible performance for the application. Determining the maximum performance obtainable using the infinite resources as a baseline, processor and application architects can now design an architecture based on constraints such as cost, time, signal, power, chip area, etc.

In one embodiment, the invention relates to a method of simulating operation of a processor to obtain performance information on the processor. The method includes providing an ideal processor model simulating the processor, executing instructions with the ideal processor model, gathering information from the executing instructions to obtain substantially ideal performance results, restricting a variable of the ideal processor model, executing instructions with the ideal processor model when the variable is restricted, gathering information from the executing instructions when a variable is restricted to obtain restricted variable performance results, and comparing the substantially ideal performance results with the variable restricted performance results to determine an effect of the restricted variable on the performance of the processor. The ideal processor model executes instructions such that the ideal processor model does not present a bottleneck when executing the instructions.

In another embodiment, the invention relates to an apparatus for simulating operation of a processor to obtain performance information on the processor. The apparatus includes an ideal processor model, means for executing instructions with the ideal processor model, means for gathering information from the executing instructions to obtain substantially ideal performance results, means for restricting a variable of the ideal processor model, means for executing instructions with the ideal processor model when the variable is restricted, means for gathering information from the executing instructions when a variable is restricted to obtain restricted variable performance results, and means for comparing the substantially ideal performance results with the variable restricted performance results to determine an effect of the restricted variable on the performance of the processor. The ideal processor model simulates the processor. The ideal processor model executes instructions such that the ideal processor model does not present a bottleneck when executing the instructions.

In another embodiment, the invention relates to a simulator to obtain performance information on a processor. The method includes an ideal processor model simulating the processor, an instruction executing module, a gathering module, a variable restricting module and a comparing module. The ideal processor model executes instructions such that the ideal processor model does not present a bottleneck when executing the instructions. The instruction executing module executes instructions with the ideal processor model. The gathering module gathers information from the executing instructions to obtain substantially ideal performance results. The variable restricting module restricts a variable of the ideal processor model. The instruction executing module executes with the ideal processor model when the variable is restricted. The gathering module gathers information from the executing instructions when a variable is restricted to obtain restricted variable performance results. The comparing module compares substantially ideal performance results with the variable restricted performance results to determine the effect of the restricted variable on the performance of the processor.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram showing an ideal processor model employed in a simulator of the present invention.

FIG. 2 shows a flow chart of the operation of a simulation using an ideal machine simulator.

FIG. 3 shows a flow chart of the operation of a simulation using an ideal processor simulator.

### DETAILED DESCRIPTION

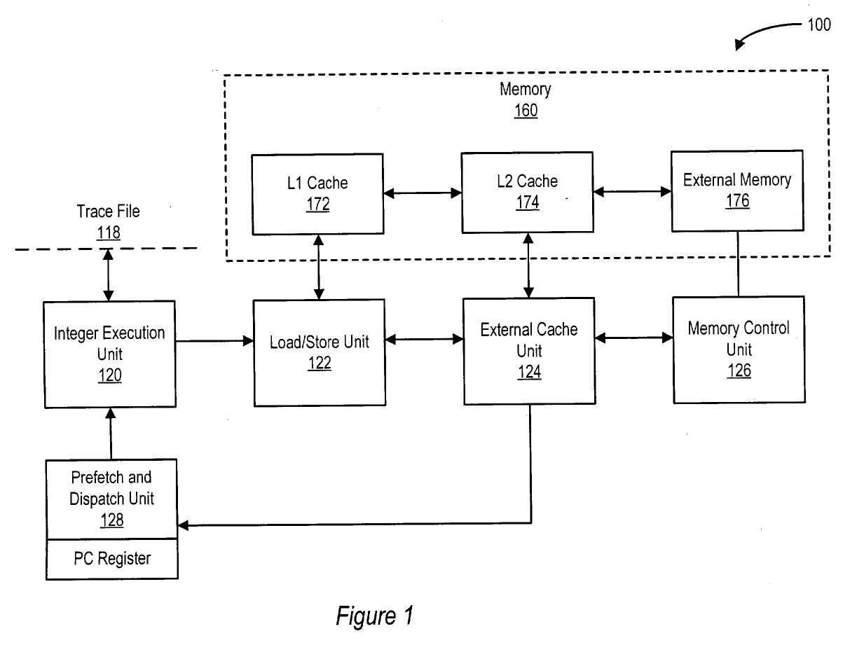

Referring to FIG. 1, certain details of an exemplary ideal processor model 100 such as, for example, a SPARC processor available from Sun Microsystems, Inc. are shown. The ideal processor model 100 includes modules for modeling an external cache unit (“ECU”) 124, a prefetch and dispatch unit (“PDU”) 128, an integer execution unit (“IEU”) 120, a load/store unit (“LSU”) 122 and a memory control unit (“MCU”) 126, as well as a memory 160. Memory 160 includes modules representing a level 1 cache (L1 cache) 172, a level 2 cache (L2 cache) 174 and an external memory 176. Other cache levels may also be included with the memory model. The level 1 cache 172 interacts with the load store unit 122 and the level 2 cache 174. The level 2 cache 174 interacts with the level 1 cache 172, the external memory 176 and the external cache unit 124. The external memory 124 interacts with the level 2 cache 174 and the memory control unit 126.

Each of these processor units are implemented as software objects, and the instructions delivered between the various objects which represent the units of the processor are provided as packets containing such information as the address of an instruction, the actual instruction word, etc. By endowing the objects with the functional attributes of actual processor elements, the model can provide cycle-by-cycle correspondence with the HDL representation of the processor being modeled.

Memory 160 stores a static version of a program (e.g. a benchmark program) to be executed on processor model 100. The instructions in the memory 160 are provided to processor 100 via the memory control unit 126. The instructions are then stored in external cache unit 124 and are available to both prefetch and dispatch unit 128 and load/store unit 122. As new instructions are to be executed, the instructions are first provided to prefetch and dispatch unit 128 from external cache unit 124. Prefetch and dispatch unit 128 then provides an instruction stream to integer execution unit 124 which is responsible for executing the logical instructions presented to the integer execution unit 120. LOAD or STORE instructions (which cause load and store operations to and from memory 110) are forwarded to load/store unit 122 from integer execution unit 120. The load/store unit 122 may then make specific load/store requests to external cache unit 124.

The integer execution unit 120 receives previously executed instructions from trace file 118. Some trace file instructions contain information such as the effective memory address of a LOAD or STORE operation and the outcome of decision control transfer instruction (i.e., a branch instruction) during a previous execution of a benchmark program. Because the trace file 118 specifies effective addresses for LOADS/STORES and branch instructions, the integer execution unit 120 is adapted to defer to the trace file instructions 118.

The objects of the processor model 100 accurately model the instruction pipeline of the processor design the model represents. More specifically, FIG. 4 presents an exemplary cycle-by-cycle description of how seven sequential assembly language instructions might be treated in a superscalar processor which can be appropriately modeled by a processor model 100. The prefetch and dispatch unit 128 handles the fetch (F) and decode (D) stages. Thereafter, the integer execution unit 120 handles the remaining stages which include application of the grouping logic (G), execution of Boolean arithmetic operations (E), cache access for load/store instructions (C), execution of floating point operations (three cycles represented by N₁-N₃), and insertion of values into the appropriate register files (W). Among the functions of the execute stage is calculation of effective addresses for load/store instructions. Among the functions of the cache access stage is determination if data for the load/store instruction is already in the external cache unit.

In a superscalar architecture, multiple instructions can be fetched, decoded, etc. in a single cycle. The exact number of instructions simultaneously processed is a function of the maximum capacity of pipeline as well as the “grouping logic” of the processor. In general, the grouping logic controls how many instructions (typically between 0 and 4) can be simultaneously dispatched by the IEU. Grouping logic rules may be divided into two types: (1) data dependencies, and, (2) resource dependencies. The resource is the resource available on the processor. For example, the processor may have two arithmetic logic units (ALUs). If more than two instructions requiring use of the ALUs are simultaneously presented to the pipeline, the appropriate resource grouping rule will prevent the additional arithmetic instruction from being submitted to the microprocessor pipeline. In this case, the grouping logic has caused less than the maximum number of instructions to be processed simultaneously. An example of a data dependency rule is if one instruction writes to a particular register, no other instruction which accesses that register (by reading or writing) may be processed in the same group.

The processor model 100 is an ideal machine. This means that the hardware will not be a bottleneck (as the processor model 100 executes any number of instructions in a cycle). When executing a program on this processor model 100, the program itself becomes the bottleneck. Thus, a designer can explore the properties of a program.

Accordingly, the ideal processor module 100 allows, a method of evaluating the performance of an application on a processor having infinite resources and executing an existing application on this ideal processor. Such a method advantageously allows deriving the properties of the application and determination of bottlenecks in the application. After the application is executed on the ideal processor model, the application is compiled for the ideal processor and any performance improvement opportunities are evaluated. Such a system assists in determining which parts of an application, even with infinite processor resources, do not use all the resources for the processor. By identifying the available resources, the application can be configured to use these resources and thus to get a maximum possible performance for the application. By determining the maximum performance obtainable using the infinite resources as a baseline, processor and application architects can design an architecture based on constraints such as cost, time, signal, power, chip area, etc.

More specifically, examples of resources that are simulated as ideal include the number of clock cycles needed to execute an instruction, cache performance characteristics, latency characteristics, functional unit limitations, the number of outstanding memory misses and other processor resources. The other processor resources include, e.g., a store queue, a load queue, registers, memory buffers and a translation look aside buffer (TLB).

With the ideal processor model, the infinite value of the number of clock cycles needed to execute an instruction is set as one instruction executed every clock cycle. Restricting the clock cycle value increases the number of cycles to execute an instruction.

With the ideal processor model, the infinite value for the cache performance characteristics is set such that no cache misses occur. Restricting this value adjusts how many cache misses might occur. The cache performance characteristics may be restricted by restricting the size of the cache, by restricting the replacement policy of the cache or by restricting the number of associated ways within the cache. Additionally, the number of levels of cache may be restricted. For example, the size of the level 1 cache may be restricted while maintaining an ideal level 2 cache. Also for example, the size of the level 1 and level 2 caches may be restricted while maintaining an ideal external memory. Also for example, the characteristics of each level cache may be restricted (e.g., the size of the level 1 cache may be restricted but the replacement policy may be maintained as ideal.)

With the ideal processor model, the infinite value for the latency characteristics is set such that there is always instant availability for all processor resources. Restricting this value increases the number of cycles needed to obtain data.

With the ideal processor model, the infinite value for the functional unit limitations is set such that a functional unit is always available to execute the instruction. Restricting this value restricts the number of functional units. Individual functional units may be individually restricted. For example, the processor model may be set to have an infinite number of load store units, but a limited number of integer units. Another example might restrict the number of floating point units within the processor model.

With the ideal processor model, the infinite value for the number of outstanding memory misses is set such that there is infinite bandwidth and no outstanding memory misses. Restricting this value would increase the number of outstanding misses.

With the ideal processor model, the infinite value for the other processor resources is set such that the other processor resources do not present a bottleneck to the execution of an instruction. Restricting this value would restrict one or a combination of these resources to potentially present bottlenecks to the execution of the program.

Many of the restrictions to the ideal processor are ranges of values. For example, the size of the level 1 cache may be adjusted to any size other than infinite when restricting the value. Adjusting the values allows the actual size of each of the modules of the processor to be optimized.

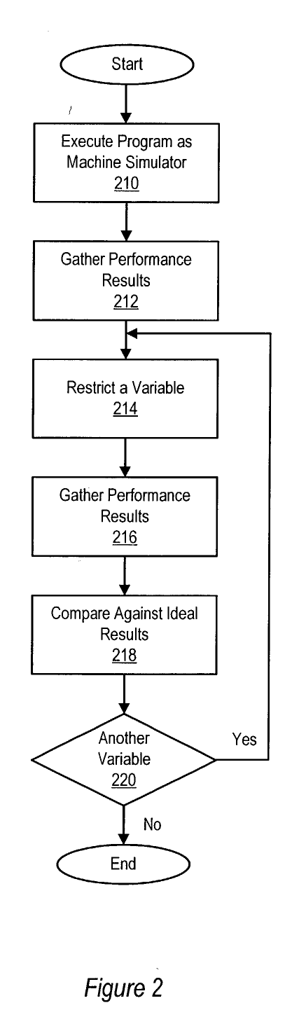

Referring to FIG. 2, in operation, a designer executes existing binaries (SPEC, Applications, Oracle) on the ideal processor model 100 at step 210. Next the performance results are gathered at step 212. The performance results of this execution might include, for example, the maximum number of execution pipeline stages (for each category) used; the maximum number of functional units used; the maximum number of cache ports used; the maximum amount of the data cache used; the maximum size of the instruction cache that is used; and the instructions per cycle (IPC).

For example, it is possible that even with an infinite number of execution pipeline stages, the execution of a binary may not use more than five load pipeline stages. Such a condition is possible as the application on which the binary is based may not use more than five independent load streams.

With these performance statistics, a processor architect can surmise that even by designing a processor which has more of a particular value than the maximum utilized, no performance improvement would be realized.

Next, at step 214, one of the variables used in step 210 is restricted. For example, the data cache size may be restricted to 50% of maximum size used during the execution at step 210. However, because the data cache size has been restricted to 50%, the level 1 cache 172 now includes a next level cache structure (i.e., a level 2 (L2) cache 174). To determine the performance of the restricted level 1 cache 172, the L2 cache 174 is configured to simulate a perfect L2 cache (i.e., an L2 cache with infinite size and infinite bandwidth to the L2 cache).

After the variable is restricted, then the performance results are gathered at step 216. Because one of the variables is restricted, the IPC is reduced. Next, the gathered performance results based upon the restricted variable are compared against the ideal results at step 218. For example, by varying size of the data cache and collecting the performance results, a graph of the performance results may be generated to determine an optimal size, associativity, and replacement policy.

After one of the variables is restricted, then the method determines whether to restrict another variable at step 220. Similarly, the method restricts one variable at a time and collects the performance results for each restricted variable. After information relating to the restriction of the variables desired to be restricted are gathered, the method ends.

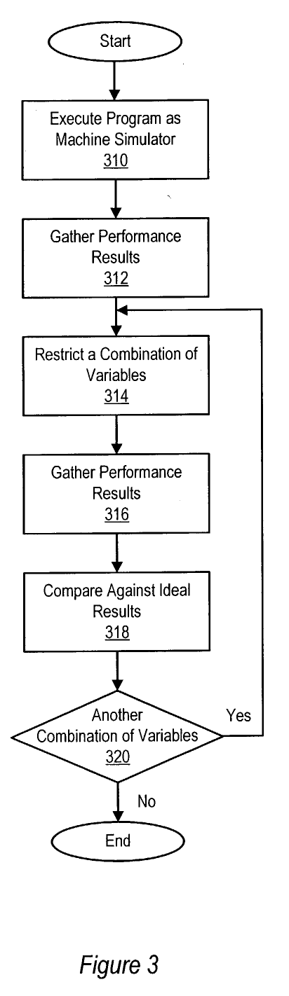

Referring to FIG. 3, a flow chart of a method in which multiple variables are simultaneously restricted is shown. More specifically, a designer executes existing binaries (SPEC, Applications, Oracle) on the processor model 100 at step 310. Next the performance results are gathered at step 312. The performance results of this execution may include, for example, the maximum number of execution pipeline stages (of each category) used; the maximum number of functional units used; the maximum number of cache ports used; the maximum amount of the data cache used; the maximum size of the instruction cache that is used; the maximum number of memory banks, the maximum number of memory controllers and the IPC.

Next, at step 314, a combination of the variables used at step 310 are restricted. After the combination of variables are restricted, then the performance results are gathered at step 316. Next, the gathered performance results based upon the combination of restricted variables are compared against the ideal results at step 318.

After one combination of the variables is restricted, then the method determines whether to restrict another combination of variables at step 320. The method restricts various combinations of variable restrictions and collects the performance results for each combination of restricted variables. After the performance results are gathered for all of the desired combinations of restricted variables and compared, the method ends.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while FIG. 2 sets forth a method in which a single variable is varied and FIG. 3 sets forth a method in which a combination of variables is varied, it will be appreciated that a single method may be used in which a single variable is varied and a combination of variables is varied.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

What is claimed is:

1. A method of predicting processor design performance, the method comprising:
providing an ideal processor model simulating the processor design, the ideal processor model executing instructions such that the ideal processor model does not present a bottleneck when executing the instructions;
executing instructions with the ideal processor model;
gathering information from the executing instructions to obtain substantially ideal performance results;
restricting a variable of the ideal processor model;
executing instructions with the ideal processor model when the variable is restricted;
gathering information from the executing instructions when a variable is restricted to obtain restricted variable performance results; and
comparing the substantially ideal performance results with the variable restricted performance results to determine an effect of the restricted variable on the performance of the processor.

2. The method of simulating operation of a processor of claim 1 wherein
the ideal processor model includes a first level cache module, the first level module simulating operation of a first level cache within the processor; and
the variable that is restricted restricts the operation of the first level cache module.

3. The method of simulating operation of a processor of claim 2 wherein
the ideal processor model includes a second level cache module, the second level cache module simulating operation of a second level cache within the processor; and
the variable that is restricted restricts the operation of the second level cache module.

4. The method of simulating operation of a processor of claim 1 wherein
the ideal processor model includes an execution pipeline module, the execution pipeline module simulating operation of an execution pipeline function within the processor; and
the variable that is restricted restricts the operation of the execution pipeline module.

5. The method of simulating operation of a processor of claim 1 wherein
the ideal processor model includes a branch prediction module, the execution pipeline module simulating operation of a branch prediction function within the processor; and
the variable that is restricted restricts the operation of the branch prediction module.

6. The method of simulating operation of a processor of claim 1 wherein
the ideal processor model includes a functional unit module, the functional unit module simulating operation of functional units within the processor; and
the variable that is restricted restricts the operation of the functional unit module.

7. An apparatus for predicting processor design performance, the apparatus comprising:
an ideal processor model, the ideal processor model simulating the processor, the ideal processor model executing instructions such that the ideal processor model does not present a bottleneck when executing the instructions;
means for executing instructions with the ideal processor model;
means for gathering information from the executing instructions to obtain substantially ideal performance results;
means for restricting a variable of the ideal processor model;
means for executing instructions with the ideal processor model when the variable is restricted;
means for gathering information from the executing instructions when a variable is restricted to obtain restricted variable performance results; and
means for comparing the substantially ideal performance results with the variable restricted performance results to determine an effect of the restricted variable on the performance of the processor.

8. The apparatus of simulating operation of a processor of claim 7 wherein
the ideal processor model includes a first level cache module, the first level cache module simulating operation of a first level cache within the processor; and
the variable that is restricted restricts the operation of the first level cache module.

9. The apparatus of simulating operation of a processor of claim 8 wherein
the ideal processor model includes a second level cache module, the second level cache module simulating operation of a second level cache within the processor; and
the variable that is restricted restricts the operation of the second level cache module.

10. The apparatus of simulating operation of a processor of claim 7 wherein
the ideal processor model includes an execution pipeline module, the execution pipeline module simulating operation of an execution pipeline function within the processor; and
the variable that is restricted restricts the operation of the execution pipeline module.

11. The apparatus of simulating operation of a processor of claim 7 wherein
the ideal processor model includes a branch prediction module, the execution pipeline module simulating operation of a branch prediction function within the processor; and
the variable that is restricted restricts the operation of the branch prediction module.

12. The method of simulating operation of a processor of claim 7 wherein
the ideal processor model includes a functional unit module, the functional unit module simulating operation of functional units within the processor; and
the variable that is restricted restricts the operation of the functional unit module.

13. A simulator to obtain performance information on a processor, the method comprising:
an ideal processor model simulating the processor, the ideal processor model executing instructions such that the ideal processor model does not present a bottleneck when executing the instructions;
an instruction executing module, the instruction executing module executing instructions with the ideal processor model;
a gathering module, the gathering module gathering information from the executing instructions to obtain substantially ideal performance results;
a variable restricting module, the variable restricting module restricting a variable of the ideal processor model, the instruction executing module with the ideal processor model when the variable is restricted, the gathering module gathering information from the executing instructions when a variable is restricted to obtain restricted variable performance results; and
a comparing module, the comparing module comparing the substantially ideal performance results with the variable restricted performance results to determine an effect of the restricted variable on the performance of the processor.

14. The method of simulating operation of a processor of claim 13 wherein
the ideal processor model includes a first level cache module, the first level cache module simulating operation of a first level cache within the processor; and
the variable that is restricted restricts the operation of the first level cache module.

15. The method of simulating operation of a processor of claim 14 wherein
the ideal processor model includes a second level cache module, the second level cache module simulating operation of a second level cache within the processor; and
the variable that is restricted restricts the operation of the second level cache module.

16. The method of simulating operation of a processor of claim 13 wherein
the ideal processor model includes an execution pipeline module, the execution pipeline module simulating operation of an execution pipeline function within the processor; and
the variable that is restricted restricts the operation of the execution pipeline module.

17. The method of simulating operation of a processor of claim 13 wherein
the ideal processor model includes a branch prediction module, the execution pipeline module simulating operation of a branch prediction function within the processor; and
the variable that is restricted restricts the operation of the branch prediction module.

18. The method of simulating operation of a processor of claim 13 wherein
the ideal processor model includes a functional unit module, the functional unit module simulating operation of functional units within the processor; and
the variable that is restricted restricts the operation of the functional unit module.
